(19) United States
(12) Patent Application Publication
(10) Pub. No.: US 2026/0268536 A1
(43) Pub. Date: Sep. 10, 2026

(54) INTERACTION METHOD, APPARATUS, ELECTRONIC DEVICE, AND STORAGE MEDIUM

(71) Applicants: Beijing Zitiao Network Technology Co., Ltd., Beijing (CN); BYTEDANCE TECHNOLOGY LTD., Grand Cayman (KY)

(72) Inventors: Linyi ZHENG, Los Angeles, CA (US); Wei ZHANG, Beijing (CN); Dongzhe ZHU, Beijing (CN); Jianzhou ZHOU, Beijing (CN); Zhichao ZHANG, Beijing (CN); Rendan PAN, Beijing (CN)

(21) Appl. No.: 19/559,391

(22) Filed: Mar. 6, 2026

(30) Foreign Application Priority Data
Mar. 7, 2025 (CN) 202510269936.2

(51) Int. Cl. G06T 11/00; H04N 21/81

(52) U.S. Cl. CPC G06T 11/00; H04N 21/816

(57) ABSTRACT

An interaction method and apparatus, an electronic device, and a storage medium are provided. The method includes: displaying a prompt generation page, the prompt generation page including a first input area and a first confirmation option associated with the first input area; in response to a selection operation on the first confirmation option, generating a first prompt based on information in the first input area; displaying, on the prompt generation page, the first prompt and a second confirmation option corresponding to the first prompt; and in response to a selection operation on the second confirmation option, generating a target media file based on the first prompt.

### CROSS-REFERENCE TO RELATED APPLICATION

The present application claims priority to Chinese Patent Application No. 202510269936.2, filed on Mar. 7, 2025, which is incorporated herein by reference in its entirety as a part of the present application.

### TECHNICAL FIELD

The present disclosure relates to the field of artificial intelligence technologies, and in particular, to an interaction method and apparatus, an electronic device, and a storage medium.

### BACKGROUND

With the rapid development of science and technology, media file generation technology has become an important achievement in the digital field today. With the help of advanced algorithm models, corresponding media files can be generated according to specific input instructions or parameters. This technology has brought innovation opportunities for many fields.

However, the current media file generation technology relies on a prompt input by a user to generate a media file. In practical applications, prompts provided by non-professional users are often of poor quality, which directly affects the quality and accuracy of the media file generated by a media file generation model. Therefore, how to assist a user to accurately construct a prompt for guiding media file generation is an urgent problem to be solved.

### SUMMARY

In order to solve the above technical problems or at least partially solve the above technical problems, embodiments of the present disclosure provide an interaction method and apparatus, an electronic device, and a storage medium.

In a first aspect, an embodiment of the present disclosure provides an interaction method, including:

displaying a prompt generation page, the prompt generation page including a first input area and a first confirmation option associated with the first input area;

in response to a selection operation on the first confirmation option, generating a first prompt based on information in the first input area;

displaying, on the prompt generation page, the first prompt and a second confirmation option corresponding to the first prompt; and

in response to a selection operation on the second confirmation option, generating a target media file based on the first prompt.

In a second aspect, an embodiment of the present disclosure further provides an interaction apparatus, including:

a prompt generation page display module, configured to display a prompt generation page, the prompt generation page including a first input area and a first confirmation option associated with the first input area;

a prompt generation module, configured to, in response to a selection operation on the first confirmation option, generate a first prompt based on information in the first input area;

a prompt display module, configured to display, on the prompt generation page, the first prompt and a second confirmation option corresponding to the first prompt; and

a media file generation module, configured to, in response to a selection operation on the second confirmation option, generate a target media file based on the first prompt.

In a third aspect, the present disclosure further provides an electronic device, the electronic device including:

one or more processors;

a non-transitory storage apparatus, configured to store one or more programs,

the one or more programs, when executed by the one or more processors, cause the one or more processors to implement the interaction method according to the above.

In a fourth aspect, an embodiment of the present disclosure further provides a non-transitory computer-readable storage medium, on which a computer program is stored, the computer program, when executed by a processor, implements the interaction method according to the above.

Compared with the prior art, the technical solution provided by the embodiments of the present disclosure has the following advantages.

The technical solution provided by the embodiments of the present disclosure includes: displaying a prompt generation page, the prompt generation page including a first input area and a first confirmation option associated with the first input area; in response to a selection operation on the first confirmation option, generating a first prompt based on information in the first input area; displaying, on the prompt generation page, the first prompt and a second confirmation option corresponding to the first prompt; and in response to a selection operation on the second confirmation option, generating a target media file based on the first prompt. The essence is to use a large language model to assist a user in creating the first prompt, thereby improving the quality of the prompt provided by a non-professional user for a media file generation model, such as solving the problem of fuzzy and inaccurate expression of the prompt or missing key information, and then improving the quality and accuracy of the media file generated by the media file generation model.

### BRIEF DESCRIPTION OF DRAWINGS

The drawings herein, which are incorporated in and constitute a part of this specification, illustrate embodiments consistent with the present disclosure and, together with the description, serve to explain the principles of the present disclosure.

In order to more clearly explain the technical solutions in the embodiments of the present disclosure or in the prior art, the following will briefly introduce the drawings that need to be used in the description of the embodiments or the prior art. Obviously, for those of ordinary skill in the art, other drawings may be obtained based on these drawings without paying creative efforts.

FIG. 1 is a flowchart of an interaction method provided by an embodiment of the present disclosure;

FIG. 2 to FIG. 7 are schematic diagrams of display interfaces of several electronic devices provided by embodiments of the present disclosure;

FIG. 8 is a schematic structural diagram of an interaction apparatus provided by an embodiment of the present disclosure; and

FIG. 9 is a schematic structural diagram of an electronic device provided by an embodiment of the present disclosure.

### DETAILED DESCRIPTION OF EMBODIMENTS

In order to understand the above objects, features and advantages of the present disclosure more clearly, the solutions of the present disclosure will be further described below. It should be noted that the embodiments of the present disclosure and the features in the embodiments may be combined with each other without conflict.

Many specific details are set forth in the following description to facilitate a full understanding of the present disclosure, but the present disclosure may also be implemented in other ways different from those described herein; obviously, the described embodiments are part of the embodiments of the present disclosure, but not all of the embodiments.

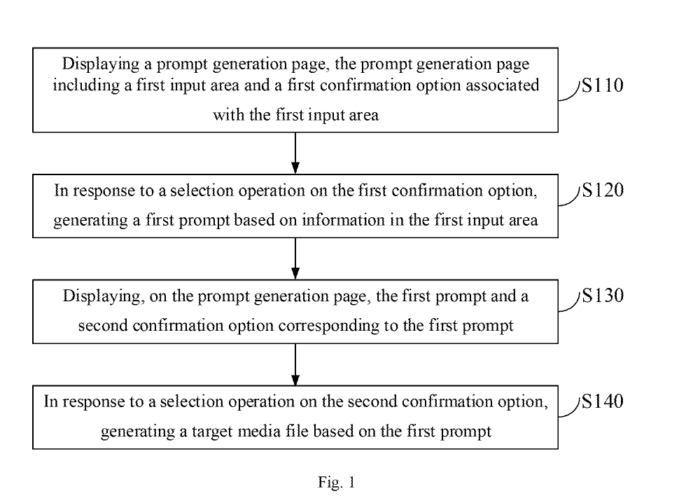

FIG. 1 is a flowchart of an interaction method provided by an embodiment of the present disclosure. The embodiment may be applied to a case of interaction in a client. The method may be executed by an interaction apparatus, which may be implemented in a form of software and/or hardware and may be configured in an electronic device, such as a terminal, specifically including but not limited to a smart phone, a palmtop computer, a tablet computer, a wearable device with a display screen, a desktop computer, a laptop computer, an all-in-one machine, a smart home device, etc. Alternatively, the embodiment may be applied to a case of interaction in a server. The method may be executed by an interaction apparatus, which may be implemented in a form of software and/or hardware and may be configured in an electronic device, such as a server.

As shown in FIG. 1, the method may specifically include the following steps.

S110: displaying a prompt generation page, the prompt generation page including a first input area and a first confirmation option associated with the first input area.

The prompt generation page may be, for example, a page related to a large language model, which may assist a user in generating a prompt with the help of the large language model. The prompt generated through the prompt generation page may be applied to media file generation. Herein, the media file may be an image, a video, an audio, or the like.

The first input area may be, for example, an information input area located on the prompt generation page. In some scenarios, a user may interact with the large language model in a form of "dialogue". The first input area is specifically used for inputting information that the user expects to interact with the large language model. Optionally, the first input area may include a text input area. Further, the first input area may further include a file upload entry. The file upload entry may be used for uploading files such as an image, a video, or an audio. In other words, the information input through the first input area may be at least one of the following: text information and an uploaded file.

The first confirmation option being associated with the first input area means that if the first confirmation option is selected, it means that the user confirms to generate a prompt based on the information in the current first input area.

S120: in response to a selection operation on the first confirmation option, generating a first prompt based on information in the first input area.

The selection operation on the first confirmation option may be, for example, a click operation, a slide operation, or a drag operation on the first confirmation option, etc.

"Generating the first prompt based on the information input in the first input area" may include, for example, inputting the information in the current first input area into the large language model, so that the large language model generates the first prompt based on the information input in the first input area.

In practice, "generating the first prompt based on the information input in the first input area" may include: inputting the information in the current first input area and a historical media file generation record into the large language model, so that the large language model generates the first prompt. The historical media file generation record may be, for example, a record about a user's historical generation of media files.

S130: displaying, on the prompt generation page, the first prompt and a second confirmation option corresponding to the first prompt.

The second confirmation option corresponding to the first prompt being selected means that the user is more satisfied with the first prompt currently displayed and hopes to apply it to the subsequent media file generation process.

S140: in response to a selection operation on the second confirmation option, generating a target media file based on the first prompt.

The selection operation on the second confirmation option may be, for example, a click operation, a slide operation, or a drag operation on the second confirmation option.

"Generating the target media file based on the first prompt" may be, for example, inputting the first prompt into a media file generation model, so that the media file generation model generates the target media file. The media file generation model may be an image generation model, a video generation model, or an audio generation model, etc.

In practice, optionally, the prompt generation page includes a plurality of second confirmation options, and the plurality of second confirmation options correspond to the same first prompt; the plurality of second confirmation options correspond to different media file types; and this step may include: in response to a selection operation on a target second confirmation option among the plurality of second confirmation options, generating the target media file based on the first prompt, a type of the target media file being the same as a media file type corresponding to the target second confirmation option.

The media file type may be, for example, an image, a video, or an audio. The target second confirmation option is a selected second confirmation option.

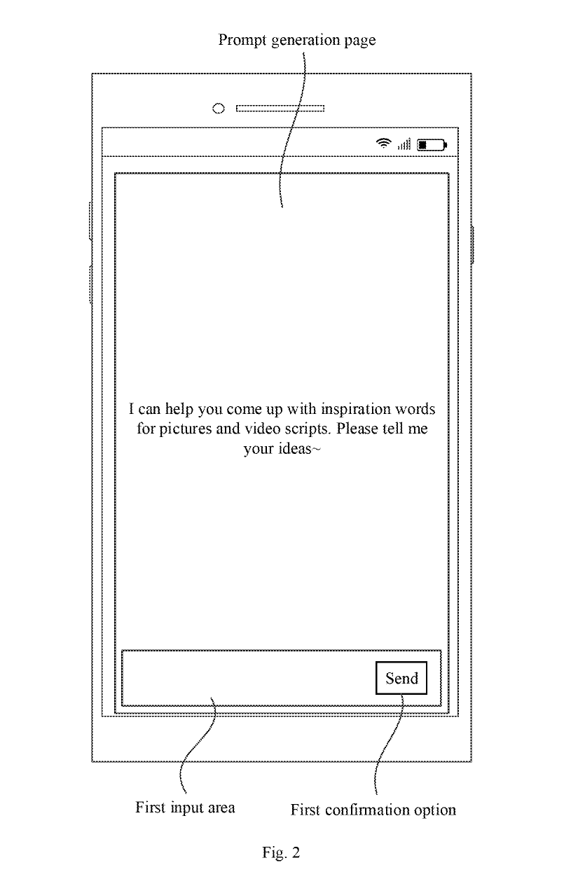

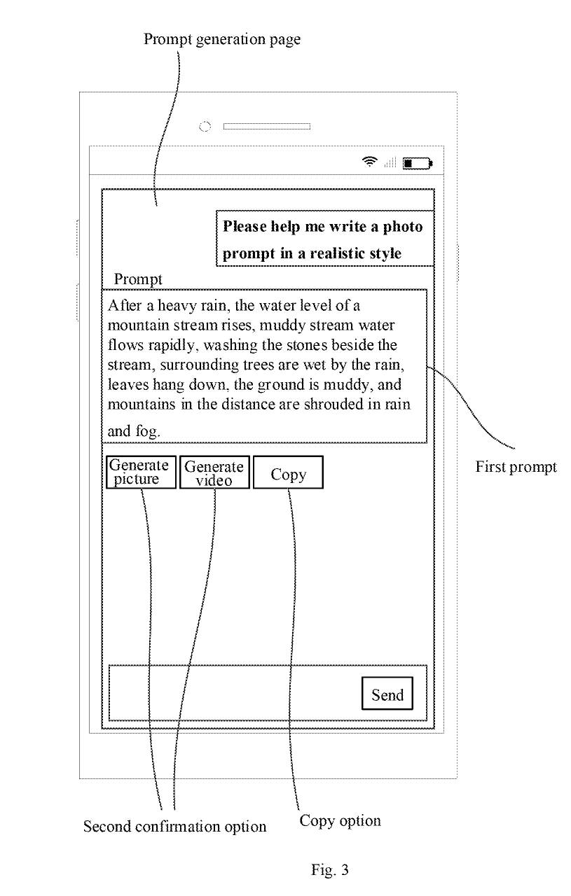

Exemplarily, the prompt generation page displayed in FIG. 2 includes a first input area and a first confirmation option associated with the first input area. The "send" option in FIG. 2 is the first confirmation option. If the user inputs "please help me write a photo prompt in a realistic style" in the first input area and clicks the "send" option, the large language model generates a first prompt based on "please help me write a photo prompt in a realistic style". Assuming that the generated first prompt is "after a heavy rain, the water level of a mountain stream rises, muddy stream water flows rapidly, washing the stones beside the stream, surrounding trees are wet by the rain, leaves hang down, the ground is muddy, and mountains in the distance are shrouded in rain and fog". Referring to FIG. 3, the first prompt and second confirmation options corresponding to the first prompt are displayed on the prompt generation page. In FIG. 3, two second confirmation options corresponding to the first prompt are included, which are a "generate picture" option and a "generate video" option, respectively. These two second confirmation options correspond to different media file types, respectively. Specifically, the media file type corresponding to the "generate picture" option is an image, and the media file type corresponding to the "generate video" option is a video. If the user clicks the "generate picture" option, an image will be generated subsequently based on the first prompt. If the user clicks the "generate video" option, a video will be generated subsequently based on the first prompt.

In the above technical solution, the method includes: displaying a prompt generation page, the prompt generation page including a first input area and a first confirmation option associated with the first input area; in response to a selection operation on the first confirmation option, generating a first prompt based on information in the first input area; displaying, on the prompt generation page, the first prompt and a second confirmation option corresponding to the first prompt; and in response to a selection operation on the second confirmation option, generating a target media file based on the first prompt. The essence is to use a large language model to assist a user in creating the first prompt, thereby improving the quality of the prompt provided by a non-professional user for a media file generation model, such as solving the problem of fuzzy and inaccurate expression of the prompt or missing key information, and then improving the quality and accuracy of the media file generated by the media file generation model.

On the basis of the above technical solution, optionally, S140 may include: in response to the selection operation on the second confirmation option, displaying a media file generation configuration page, the media file generation configuration page including a second input area and a first generation option, the second input area including the first prompt; and in response to a selection operation on the first generation option, generating a media file based on information in the second input area.

The media file generation configuration page may be, for example, a page used to collect information required for generating a media file. Exemplarily, if the media file is an image, the media file generation configuration page may be used to collect one or more of a prompt, a guide image, a model to be used, an aspect ratio of the image to be generated, and a size of the image to be generated that are required for generating the image. If the media file is a video, the media file generation configuration page may be used to collect one or more of a prompt, a guide image, a model to be used, and a duration of the video to be generated that are required for generating the video. If the media file is music, the media file generation configuration page may be used to collect one or more of a prompt, an audio duration, and a music style that are required for generating the music.

The second input area may be, for example, an input area that is on the media file generation configuration page and may be used to collect a prompt. The first generation option may be, for example, an option that triggers a media file generation model to run. After the first generation option is selected, the media file generation model generates a media file based on information collected on the media file generation configuration page. The selection operation on the first generation option may be, for example, a click operation, a slide operation, or a drag operation on the first generation option.

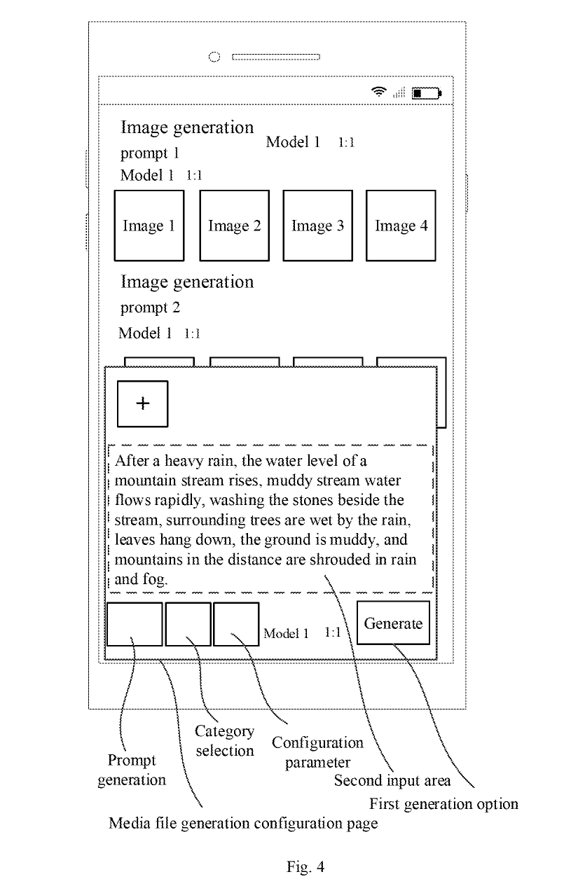

Exemplarily, on the basis of the electronic device displaying the page in FIG. 3, if the user clicks the "generate picture" option under the first prompt, referring to FIG. 4, the media file generation configuration page is displayed. The media file generation configuration page includes a second input area and a first generation option. The first prompt generated in S120 is automatically filled in the second input area. Subsequently, the user may modify the first prompt on the media file generation configuration page, or may configure or modify other information required for generating the media file other than the prompt. Exemplarily, the media file generation configuration page includes a "category selection" option and a "configuration parameter" option. The user may change a category of the media file to be generated through the "category selection" option. If the category of the current media file to be generated is an image, the user may change one or more of a model to be used, an aspect ratio of the image to be generated, and a size of the image to be generated through the "configuration parameter" option. If the category of the current media file to be generated is a video, the user may change one or more of a model to be used, a duration of the video to be generated, and an aspect ratio of a picture of the video to be generated through the "configuration parameter" option. If the user does not configure other information required for generating the media file other than the prompt, the media file may be generated using default configuration parameters. The "generate" option in FIG. 4 is the first generation option.

The method includes: in response to a selection operation on the second confirmation option, displaying a media file generation configuration page, the media file generation configuration page including a second input area and a first generation option, the second input area including the first prompt; and in response to a selection operation on the first generation option, generating a media file based on information in the second input area. The essence is that after the first prompt is determined, the media file is not generated in a hurry, but the media file generation configuration page is used to assist the user in modifying the first prompt and/or configuring other information required for generating the media file. In this way, the finally obtained target media file may better meet the needs of the user.

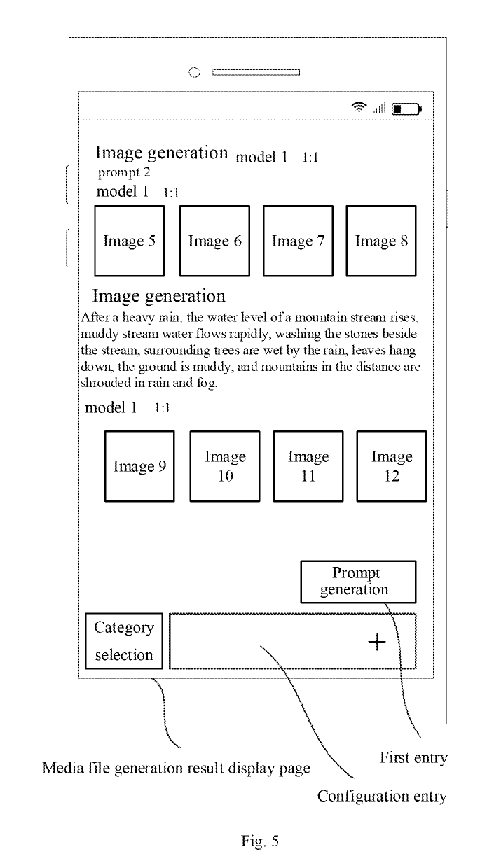

On the basis of the above technical solution, optionally, after S140, the method may further include: displaying a media file generation result display page, a media file generation result including the target media file. The media file generation result display page may be, for example, a page used to display a media file generated by a user. Exemplarily, assuming that the "generate" option in FIG. 4 is clicked (that is, the selection operation is performed on the first generation option), referring to FIG. 5, the media file generation result display page is displayed. The media file generation result display page includes media files, that is, images 9 to 12, generated based on the first prompt in the foregoing example. In this way, the user may more intuitively understand the effect of the generated target media file.

On the basis of the above technical solution, S110 may be implemented by a variety of specific methods, which is not limited in the present application. Exemplarily, in some scenarios, a specific implementation method of S110 may include: displaying a media file generation result display page, the media file generation result display page including a first entry; and in response to a trigger operation on the first entry, displaying the prompt generation page. The first entry may be, for example, a control, an option, or a link that is displayed on the media file generation result display page and that may quickly guide the user to the prompt generation page.

In some business scenarios, media file generation is a key function for some applications or websites. Therefore, the media file generation result display page is usually placed on a front-level page of the application or website. A front-level page means that the page is at a relatively shallow level in the entire page architecture, and the user may reach the page without excessive jumping. This also means that the media file generation result display page is easily found by the user. The first entry is set on the media file generation result display page, which aims to set the first entry on a page that is easily discovered by the user, so as to facilitate the user to use the technical solution provided by the present application.

Further, the media file generation result display page may be set to further include a configuration entry, and on the media file generation result display page, a position of the first entry is adjacent to a position of the configuration entry.

The configuration entry may be, for example, a control, an option, or a link that is displayed on the media file generation result display page and that may quickly guide the user to the media file generation configuration page.

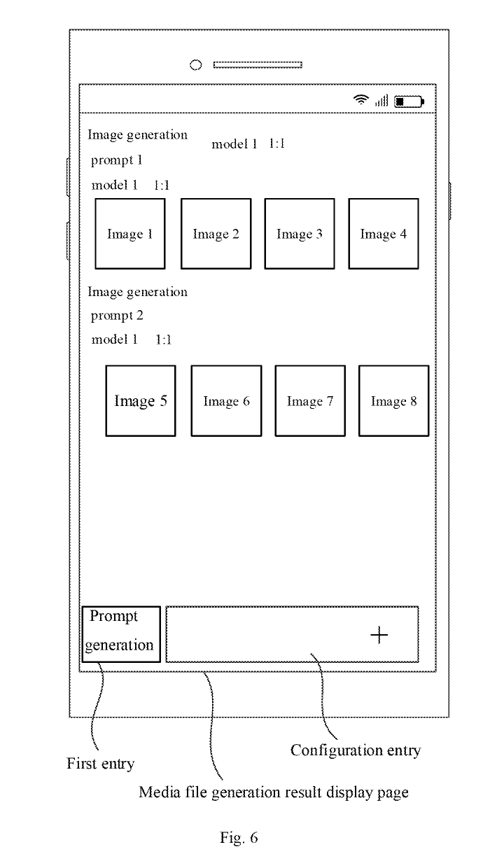

Exemplarily, referring to FIG. 5, the configuration entry is located at the bottom of the media file generation result display page. The position of the first entry is located above the position of the configuration entry, and the positions of the first entry and the configuration entry are adjacent to each other up and down. FIG. 6 is a schematic diagram of another media file generation result display page provided by the embodiment of the present disclosure. In FIG. 6, the first entry and the configuration entry are both located at the bottom of the media file generation result display page. Moreover, the positions of the first entry and the configuration entry are adjacent to each other left and right.

By setting the position of the first entry to be adjacent to the position of the configuration entry, it is convenient for the user to quickly find the first entry when there is a need to generate a media file, and then use the technical solution provided by the present application to generate the media file.

In some other scenarios, a specific implementation method of S110 may include: displaying a media file generation result display page, the media file generation result display page including a configuration entry; in response to a trigger operation on the configuration entry, displaying a media file generation configuration page, the media file generation configuration page including a second input area, a first generation option, and a second entry; and in response to a trigger operation on the second entry, displaying the prompt generation page.

The trigger operation on the configuration entry may be, for example, a click operation, a slide operation, or a drag operation on the configuration entry.

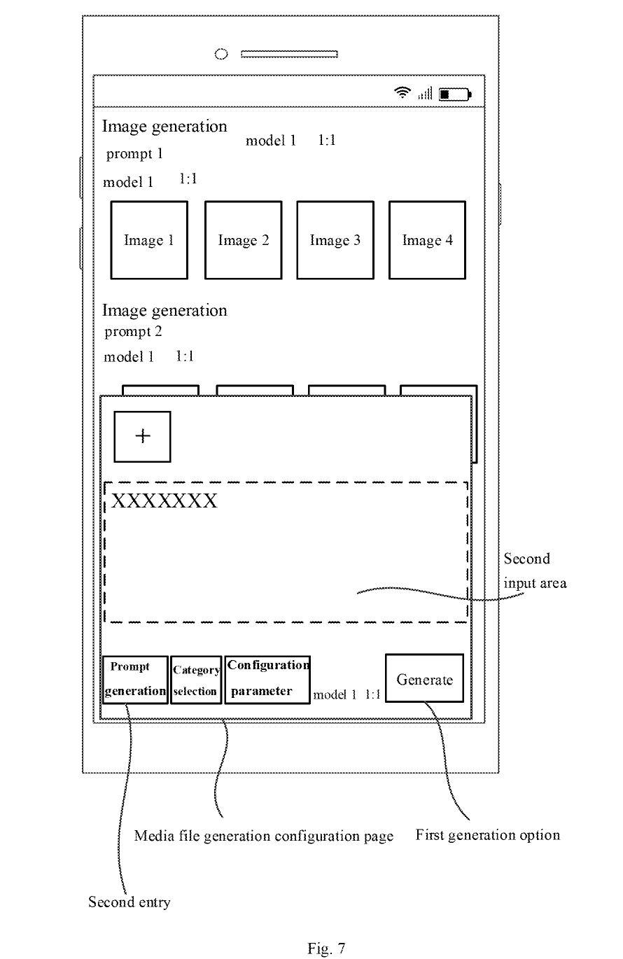

Exemplarily, referring to FIGS. 5 or 6, if the user clicks the configuration entry, referring to FIG. 7, the media file generation configuration page is displayed. The media file generation configuration page includes a "prompt generation" option. The "prompt generation" option is the second entry, and if the user clicks the "prompt generation" option, the prompt generation page is displayed.

By setting the media file generation configuration page to include the second entry, it is convenient for the user to quickly find the second entry when there is a need to generate a media file, and then use the technical solution provided by the present application to generate the media file.

Further, "in response to the trigger operation on the second entry, displaying the prompt generation page" may be set to include: if the second input area in the media file generation configuration page includes second prompt information, in response to the trigger operation on the second entry, displaying the prompt generation page, the first input area of the prompt generation page including the second prompt information.

Exemplarily, still referring to FIG. 7, it is assumed that the user inputs information into the second input area on the media file generation configuration page, and the input information is second prompt information. In FIG. 7, assuming that the second prompt information is "XXXXXXX", the user then clicks the "prompt generation" option (that is, the second entry) to display the prompt generation page. On the prompt generation page, "XXXXXXX" will be automatically filled in the first input area. Subsequently, if the user directly performs the selection operation on the first confirmation option without modifying the information in the first input area, the first prompt will be generated based on "XXXXXXX".

The method includes: if the second input area in the media file generation configuration page includes second prompt information, in response to the trigger operation on the second entry, displaying the prompt generation page, the first input area of the prompt generation page including the second prompt information. The purpose is to prevent the user from manually performing the step of transferring the information input in the second input area to the first input area of the prompt generation page, thereby reducing the number of operations of the user and making the operations related to media file generation more convenient.

On the basis of the above technical solutions, optionally, the method may further include: while displaying the first prompt on the prompt generation page, also displaying a copy option corresponding to the first prompt; and in response to a trigger operation on the copy option, copying the first prompt.

The trigger operation on the copy option may be, for example, a click operation, a slide operation, or a drag operation on the copy option.

Exemplarily, in FIG. 3, "copy" under the first prompt is the copy option. If the user clicks the copy option, the first prompt is copied. Subsequently, the user may paste the first prompt to other places, which is convenient for the user to use or communicate with others.

It may be understood that before using the technical solutions disclosed in the embodiments of the present disclosure, the user should be informed of the type, the scope of use, the use scenarios, etc., of the personal information involved in the present disclosure in an appropriate manner in accordance with relevant laws and regulations, and the authorization of the user should be obtained.

For example, in response to receiving an active request from a user, prompt information is sent to the user to clearly prompt the user that the requested operation will require access to and use of the user's personal information. In this way, the user may independently choose, according to the prompt information, whether to provide the personal information to software or hardware, such as an electronic device, an application, a server, or a storage medium, that performs the operations of the technical solutions of the present disclosure.

As an optional but non-limiting implementation, in response to receiving an active request from a user, a manner of sending prompt information to the user may be, for example, a pop-up window, in which the prompt information may be presented in text. In addition, the pop-up window may further include a selection control for the user to select "agree" or "disagree" to provide the personal information to the electronic device.

It may be understood that the above process of notifying and obtaining user authorization is only illustrative and does not limit the implementations of the present disclosure, and other manners that satisfy relevant laws and regulations may also be applied to the implementations of the present disclosure.

It should be noted that, for the sake of simple description, the foregoing method embodiments are all expressed as a series of action combinations, but those skilled in the art should know that the present invention is not limited by the described action order, because according to the present invention, certain steps may be performed in other orders or simultaneously. Secondly, those skilled in the art should also know that the embodiments described in the specification all belong to preferred embodiments, and the actions and modules involved are not necessarily essential to the present invention.

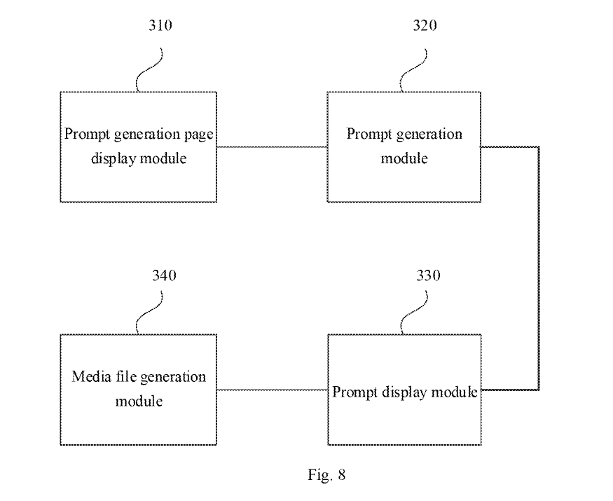

FIG. 8 is a schematic structural diagram of an interaction apparatus according to an embodiment of the present disclosure. The interaction apparatus provided by the embodiment of the present disclosure may be configured in a client or may be configured in a server. Referring to FIG. 8, the interaction apparatus specifically includes:

a prompt generation page display module 310, configured to display a prompt generation page, the prompt generation page including a first input area and a first confirmation option associated with the first input area;

a prompt generation module 320, configured to, in response to a selection operation on the first confirmation option, generate a first prompt based on information in the first input area;

a prompt display module 330, configured to display, on the prompt generation page, the first prompt and a second confirmation option corresponding to the first prompt; and

a media file generation module 340, configured to, in response to a selection operation on the second confirmation option, generate a target media file based on the first prompt.

Further, the media file generation module 340 is configured to:

in response to the selection operation on the second confirmation option, display a media file generation configuration page, the media file generation configuration page including a second input area and a first generation option, the second input area including the first prompt; and

in response to a selection operation on the first generation option, generate a media file based on information in the second input area.

Further, the prompt generation page includes a plurality of second confirmation options, the plurality of second confirmation options correspond to the same first prompt, and the plurality of second confirmation options correspond to different media file types; the media file generation module 340 is configured to:

in response to a selection operation on a target second confirmation option among the plurality of second confirmation options, generate a target media file based on the first prompt, a type of the target media file being the same as a media file type corresponding to the target second confirmation option.

Further, the prompt generation page display module 310 is configured to:

display a media file generation result display page, the media file generation result display page including a first entry; and

in response to a trigger operation on the first entry, display the prompt generation page.

Further, the media file generation result display page further includes a configuration entry, and on the media file generation result display page, a position of the first entry is adjacent to a position of the configuration entry.

Further, the prompt generation page display module 310 is configured to:

display a media file generation result display page, the media file generation result display page including a configuration entry;

in response to a trigger operation on the configuration entry, display a media file generation configuration page, the media file generation configuration page including a second input area, a first generation option, and a second entry; and

in response to a trigger operation on the second entry, display the prompt generation page.

Further, the prompt generation page display module 310 is configured to:

if the second input area in the media file generation configuration page includes second prompt information, in response to the trigger operation on the second entry, display the prompt generation page, the first input area of the prompt generation page including the second prompt information.

Further, the prompt display module is configured to:

while displaying the first prompt on the prompt generation page, also display a copy option corresponding to the first prompt; and

in response to a trigger operation on the copy option, copy the first prompt.

The interaction apparatus provided by the embodiment of the present disclosure can execute the steps executed by the client or the server in the interaction method provided by the method embodiment of the present disclosure, and has the execution steps and beneficial effects, which will not be repeated herein.

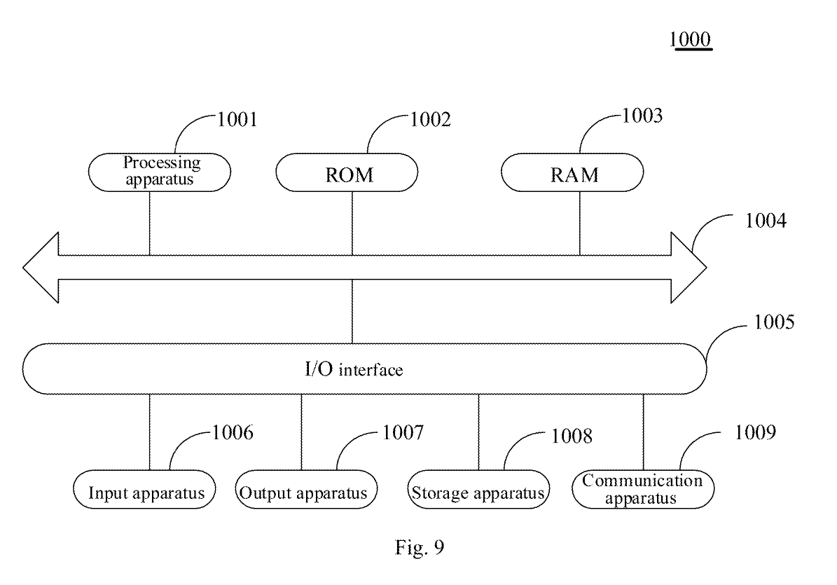

FIG. 9 is a schematic structural diagram of an electronic device according to an embodiment of the present disclosure. The following specifically refers to FIG. 9, which shows a schematic structural diagram of an electronic device 1000 suitable for implementing the embodiments of the present disclosure. The electronic device 1000 in the embodiments of the present disclosure may include, but is not limited to, mobile terminals such as a mobile phone, a laptop computer, a digital broadcast receiver, a personal digital assistant (PDA), a tablet computer (PAD), a portable multimedia player (PMP), a vehicle-mounted terminal (such as a vehicle navigation terminal), and a wearable electronic device, and fixed terminals such as a digital TV, a desktop computer, and a smart home device. The electronic device shown in FIG. 9 is only an example, and should not impose any limitation to the functions and the scope of use of the embodiments of the present disclosure.

As shown in FIG. 9, the electronic device 1000 may include a processing apparatus (such as a central processing unit, a graphics processor, etc.) 1001, which may perform various appropriate actions and processing according to a program stored in a read-only memory (ROM) 1002 or a program loaded from a storage apparatus 1008 into a random access memory (RAM) 1003 to implement the interaction method of the embodiments as described in the present disclosure. The RAM 1003 further stores various programs and information required for the operation of the electronic device 1000. The processing apparatus 1001, the ROM 1002, and the RAM 1003 are connected to each other through a bus 1004. An input/output (I/O) interface 1005 is also connected to the bus 1004.

Generally, the following apparatuses may be connected to the I/O interface 1005: an input apparatus 1006 including, for example, a touch screen, a touchpad, a keyboard, a mouse, a camera, a microphone, an accelerometer, a gyroscope, etc.; an output apparatus 1007 including, for example, a liquid crystal display (LCD), a speaker, a vibrator, etc.; the storage apparatus 1008 including, for example, a magnetic tape, a hard disk, etc.; and a communication apparatus 1009. The communication apparatus 1009 may allow the electronic device 1000 to perform wireless or wired communication with other devices to exchange information. Although FIG. 9 shows the electronic device 1000 having various apparatuses, it should be understood that not all the apparatuses shown here need to be implemented or provided. More or fewer apparatuses may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program code for executing the method shown in the flowchart, thereby implementing the interaction method as described above. In such an embodiment, the computer program may be downloaded and installed from a network through the communication apparatus 1009, or installed from the storage apparatus 1008, or installed from the ROM 1002. When the computer program is executed by the processing apparatus 1001, the above-mentioned functions defined in the method of the embodiments of the present disclosure are executed.

It should be noted that the above computer-readable medium in the present disclosure may be a computer-readable signal medium, a computer-readable storage medium, or any combination of the above two. The computer-readable storage medium may be, for example, but not limited to, an electronic, magnetic, optical, electromagnetic, infrared, or semiconductor system, apparatus, or device, or any combination of the above. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, which may be used by or in combination with an instruction execution system, apparatus, or device. In the present disclosure, the computer-readable signal medium may include an information signal propagated in a baseband or as a part of a carrier wave, in which computer-readable program code is carried. This propagated information signal may take many forms, including but not limited to an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted by any suitable medium, including but not limited to: a wire, an optical cable, a radio frequency (RF), etc., or any suitable combination of the above.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above computer-readable medium may be included in the above electronic device; or it may exist alone without being assembled into the electronic device.

The above computer-readable medium carries one or more programs, which, when executed by the electronic device, cause the electronic device to:

display a prompt generation page, the prompt generation page including a first input area and a first confirmation option associated with the first input area;

in response to a selection operation on the first confirmation option, generate a first prompt based on information in the first input area;

display, on the prompt generation page, the first prompt and a second confirmation option corresponding to the first prompt; and

in response to a selection operation on the second confirmation option, generate a target media file based on the first prompt.

Optionally, when the one or more programs are executed by the electronic device, the electronic device may further perform other steps described in the above embodiments.

The computer program code for executing the operation of the present disclosure may be written in one or more programming languages or combinations thereof, the above programming language includes but is not limited to object-oriented programming languages such as Java, Smalltalk, and C++, and also includes conventional procedural programming languages such as a "C" language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including local area network (LAN) or wide area network (WAN), or may be connected to an external computer (such as connected by using Internet provided by an Internet service provider).

The flowcharts and area diagrams in the accompanying drawings illustrate the architecture, functionality, and operation of possible implementations of systems, methods, and computer program products according to various embodiments of the present disclosure. In this regard, each block in the flowcharts or area diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the area diagrams and/or flowcharts, and combinations of blocks in the area diagrams and/or flowcharts, may be implemented by a dedicated hardware-based system that performs the specified functions or operations, or may also be implemented by a combination of dedicated hardware and computer instructions.

The involved units described in the embodiments of the present disclosure may be implemented in a form of software or in a form of hardware. Among them, the name of the unit does not constitute a limitation on the unit itself under certain circumstances.

The functions described above herein may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may contain or store programs for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more lines, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, the present disclosure provides an electronic device, including:

one or more processors;

a non-transitory memory, configured to store one or more programs,

the one or more programs, when executed by the one or more processors, cause the one or more processors to implement any one of the interaction methods provided by the present disclosure.

One or more embodiments of the present disclosure provide a computer-readable storage medium, on which a computer program is stored, the computer program, when executed by a processor, implements any one of the interaction methods provided by the present disclosure.

An embodiment of the present disclosure further provides a computer program product, which includes a computer program or instructions, the computer program or instructions, when executed by a processor, implements the interaction method as described above.

For example, in the embodiment of the present disclosure, the target media file may also be called the first media file or the media file, and the target second confirmation option may also be called the candidate second confirmation option or the third confirmation option.

It should be noted that in this article, relational terms such as "first" and "second" are only used to distinguish one entity or operation from another entity or operation, and do not necessarily require or imply any actual relationship or order between these entities or operations. Moreover, the terms "include", "including" or any other variant thereof are intended to cover non-exclusive inclusion, so that a process, method, object or device including a series of elements includes not only those elements, but also other elements not explicitly listed or elements inherent to such process, method, object or device. Without further restrictions, an element defined by the phrase "including a" does not exclude that there are other identical elements in the process, method, object or device including the element.

The above descriptions are only specific implementations of the present disclosure, so that those skilled in the art may understand or implement the present disclosure. Various modifications to these embodiments will be clearly to those skilled in the art, and the general principles defined herein may be implemented in other embodiments without departing from the spirit or scope of the present disclosure. Therefore, the present disclosure will not be limited to these embodiments described herein, but rather to the widest scope consistent with the principles and novel features disclosed herein.

1. An interaction method, comprising:
displaying a prompt generation page, the prompt generation page comprising a first input area and a first confirmation option associated with the first input area;
in response to a selection operation on the first confirmation option, generating a first prompt based on information in the first input area;
displaying, on the prompt generation page, the first prompt and a second confirmation option corresponding to the first prompt; and
in response to a selection operation on the second confirmation option, generating a first media file based on the first prompt.

2. The method according to claim 1, wherein in response to the selection operation on the second confirmation option, generating the first media file based on the first prompt comprises:
in response to the selection operation on the second confirmation option, displaying a media file generation configuration page, the media file generation configuration page comprising a second input area and a first generation option, the second input area comprising the first prompt; and
in response to a selection operation on the first generation option, generating a media file based on information in the second input area.

3. The method according to claim 1, wherein the prompt generation page comprises a plurality of second confirmation options, the plurality of second confirmation options correspond to the same first prompt, and the plurality of second confirmation options correspond to different media file types; and
in response to the selection operation on the second confirmation option, generating the first media file based on the first prompt comprises:
in response to a selection operation on a candidate second confirmation option among the plurality of second confirmation options, generating the first media file based on the first prompt, a type of the first media file being the same as a media file type corresponding to the candidate second confirmation option.

4. The method according to claim 1, wherein the displaying a prompt generation page comprises:
displaying a media file generation result display page, the media file generation result display page comprising a first entry; and
in response to a trigger operation on the first entry, displaying the prompt generation page.

5. The method according to claim 4, wherein
the media file generation result display page further comprises a configuration entry, and on the media file generation result display page, a position of the first entry is adjacent to a position of the configuration entry.

6. The method according to claim 1, wherein the displaying a prompt generation page comprises:
displaying a media file generation result display page, the media file generation result display page comprising a configuration entry;
in response to a trigger operation on the configuration entry, displaying a media file generation configuration page, the media file generation configuration page comprising a second input area, a first generation option, and a second entry; and
in response to a trigger operation on the second entry, displaying the prompt generation page.

7. The method according to claim 6, wherein in response to the trigger operation on the second entry, displaying the prompt generation page comprises:
in response to the second input area in the media file generation configuration page comprising second prompt information; in response to the trigger operation on the second entry, displaying the prompt generation page, the first input area of the prompt generation page comprising the second prompt information.

8. The method according to claim 1, further comprising:
while displaying the first prompt on the prompt generation page, also displaying a copy option corresponding to the first prompt; and
in response to a trigger operation on the copy option, copying the first prompt.

9. An electronic device, comprising:
a processor;
a non-transitory memory, configured to store a program,
the program, when executed by the processor, causes the processor to implement the method according to claim 1.

10. The electronic device according to claim 9, wherein when performing generating the first media file based on the first prompt, the processor is further caused to:
in response to the selection operation on the second confirmation option, display a media file generation configuration page, the media file generation configuration page comprising a second input area and a first generation option, the second input area comprising the first prompt; and
in response to a selection operation on the first generation option, generate a media file based on information in the second input area.

11. The electronic device according to claim 9, wherein the prompt generation page comprises a plurality of second confirmation options, the plurality of second confirmation options correspond to the same first prompt, and the plurality of second confirmation options correspond to different media file types; and
when performing generating the first media file based on the first prompt, the processor is further caused to:
in response to a selection operation on a candidate second confirmation option among the plurality of second confirmation options, generate the first media file based on the first prompt, a type of the first media file being the same as a media file type corresponding to the candidate second confirmation option.

12. The electronic device according to claim 9, wherein when performing the displaying a prompt generation page, the processor is further caused to:
display a media file generation result display page, the media file generation result display page comprising a first entry; and
in response to a trigger operation on the first entry, display the prompt generation page.

13. The electronic device according to claim 12, wherein
the media file generation result display page further comprises a configuration entry, and on the media file generation result display page, a position of the first entry is adjacent to a position of the configuration entry.

14. The electronic device according to claim 9, wherein when performing the displaying a prompt generation page, the processor is further caused to:
display a media file generation result display page, the media file generation result display page comprising a configuration entry;
in response to a trigger operation on the configuration entry, display a media file generation configuration page, the media file generation configuration page comprising a second input area, a first generation option, and a second entry; and
in response to a trigger operation on the second entry, display the prompt generation page.

15. The electronic device according to claim 14, wherein when performing displaying the prompt generation page, the processor is further caused to:
in response to that the second input area in the media file generation configuration page comprises second prompt information; in response to the trigger operation on the second entry, display the prompt generation page, the first input area of the prompt generation page comprising the second prompt information.

16. The electronic device according to claim 9, wherein the processor is further caused to:
while displaying the first prompt on the prompt generation page, also displaying a copy option corresponding to the first prompt; and
in response to a trigger operation on the copy option, copying the first prompt.

17. A non-transitory computer-readable storage medium, on which a computer program is stored, wherein the program, when executed by a processor, implements the method according to claim 1.

18. The non-transitory computer-readable storage medium according to claim 17, wherein when performing generating the first media file based on the first prompt, the processor is further caused to:
in response to the selection operation on the second confirmation option, display a media file generation configuration page, the media file generation configuration page comprising a second input area and a first generation option, the second input area comprising the first prompt; and
in response to a selection operation on the first generation option, generate a media file based on information in the second input area.

19. The non-transitory computer-readable storage medium according to claim 17, wherein the prompt generation page comprises a plurality of second confirmation options, the plurality of second confirmation options correspond to the same first prompt, and the plurality of second confirmation options correspond to different media file types; and
when performing generating the first media file based on the first prompt, the processor is further caused to:
in response to a selection operation on a candidate second confirmation option among the plurality of second confirmation options, generate the first media file based on the first prompt, a type of the first media file being the same as a media file type corresponding to the candidate second confirmation option.

20. The non-transitory computer-readable storage medium according to claim 17, wherein when performing the displaying a prompt generation page, the processor is further caused to:
display a media file generation result display page, the media file generation result display page comprising a first entry; and
in response to a trigger operation on the first entry, display the prompt generation page.
